(19) United States
(12) Patent Application Publication
(10) Pub. No.: US 2025/0198965 A1
(43) Pub. Date: Jun. 19, 2025

(54) Ion Analyzer and Ion Analyzing Method

(71) Applicant: SHIMADZU CORPORATION, Kyoto-shi (JP)

(72) Inventors: Kenta TAKIGAWA, Kyoto-shi (JP); Hidenori TAKAHASHI, Kyoto-shi (JP)

(21) Appl. No.: 18/921,786

(22) Filed: Oct. 21, 2024

(30) Foreign Application Priority Data
Dec. 14, 2023 (JP) 2023-210745

(51) Int. Cl. G01N 27/68

(52) U.S. Cl. CPC G01N 27/68

(57) ABSTRACT

Provided is an ion analyzer for analyzing an ion using radical-induced dissociation. A generator (21, 210) generates a radical from a source gas. A gas supplier (26, 3) supplies a gas mixture as the source gas to the generator during an analysis. The gas mixture is prepared by mixing a first gas which is a source for a radical having oxidizing power or which itself has oxidizing power, and a second gas which is a source for a radical having reducing power or which itself has reducing power, at a predetermined ratio specified so that the efficiency of dissociation by the radical originating from the first gas is not lower than that when the second gas is not mixed. A radical generated by the generator is introduced into a reaction chamber (132), within which an ion originating from a sample is dissociated by coming in contact with the radical.

### TECHNICAL FIELD

The present invention relates to an ion analyzer and an ion analyzing method for analyzing an ion originating from a target component contained in a sample.

### BACKGROUND ART

In order to identify a sample component (e.g., a high-molecular compound) contained in a sample and analyze its structure, the technique of mass spectrometry has been widely used in which an ion having a specific mass-to-charge ratio (m/z) is selected from ions originating from the sample component, and various product ions generated by dissociating that ion are detected after being separated from each other according to their mass-to-charge ratios. Various methods have been known as techniques for dissociating ions. One of those known techniques is a radical-induced dissociation method in which various kinds of radicals are made to attach to or react with an ion to dissociate this ion (although this technique may also be called the “radical attachment dissociation method”, the term “radical-induced dissociation method” is used in the present description).

For example, Patent Literature 1 discloses a method in which radical-induced dissociation of an ion is caused by irradiating the ion with hydroxyl (OH) radical, oxygen radical, nitrogen radical or other kinds of radicals generated by radio-frequency electric discharge, and the thereby generated product ions are subjected to mass spectrometry. Patent Literature 2 discloses that the location of a double bond which determines the bioactivity of a lipid can be analyzed by an MS/MS analysis employing a radical-induced dissociation method which uses hydroxyl and oxygen radicals.

Patent Literature 3 discloses one example of a radical generation device for generating radicals to be used in the previously described radical-induced dissociation method. This radical generation device has a helical antenna including a quartz tube with a strip of conductor wound around its outer circumferential surface. Source gas, such as steam, is introduced into the quartz tube, and radiofrequency (microwave) power is supplied to the helical antenna to generate a cloud of plasma within the quartz tube and create radicals within this plasma. A magnet generating a strong magnetic field is placed on the outside of the quartz tube. This magnetic field induces electron cyclotron resonance, which increases the density of the plasma within the quartz tube as well as stabilizes the generation of that plasma. Due to the use of the locally induced electric discharge and the electron cyclotron resonance for the generation and maintenance of the plasma, this radical generation device may also be called an ECR-LICP (Electron Cyclotron Resonance-Localized Inductively Coupled Plasma) type.

As noted earlier, various kinds of radicals can be used in radical-induced dissociation methods. It is preferable to selectively use radical species according to the purpose of the analysis, kind of compound and other factors. One possible method for selectively using various radical species in a single mass spectrometer is to change the kind of source gas supplied to the previously described type of radical generation device. For example, in the configuration adopted in a mass spectrometer disclosed in Patent Literature 4, either the hydroxyl and oxygen radicals or the hydrogen radical can be selectively introduced into the collision cell by switching the source gas between steam and hydrogen gas.

### CITATION LIST

### Patent Literature

Patent Literature 1: WO 2018/186286 A
Patent Literature 2: WO 2019/155725 A
Patent Literature 3: WO 2022/059247 A
Patent Literature 4: WO 2021/053865 A

### SUMMARY OF INVENTION

### Technical Problem

In a mass spectrometer capable of an MS/MS analysis using the previously described radical-induced dissociation (which is hereinafter called the “radical induction MS/MS analysis”), it is important to enhance the efficiency of the radical-induced dissociation so as to improve the analysis sensitivity. In order to enhance the efficiency of the radical-induced dissociation, it is important to introduce a large amount of radicals into the collision cell, make those radicals efficiently come in contact with a precursor ion injected into the collision cell, as well as collect the resulting product ions without waste and send them to the subsequent stage. However, the hydroxyl and oxygen radicals have oxidizing power and easily form metal oxides on the surface of a metallic member, such as an electrode, within the collision cell. A metal oxide film formed on the surface of an electrode or similar member causes unwanted electrostatic charging (“charge-up”) on that surface, which prevents the formation of an intended electric field, so that the behavior of the ions cannot be correctly controlled.

To address this problem, the mass spectrometer disclosed in Patent Literature 4 operates as follows: During an analysis, steam is selected as the source gas to introduce hydroxyl and oxygen radicals into the collision cell and thereby promote radical-induced dissociation of an ion originating from a sample. On the other hand, when the maintenance of the device is performed, hydrogen gas is selected as the source gas to supply hydrogen radical into the collision cell. The hydrogen radical, which is also available for dissociating ions, has a strong reducing effect and can act as a remover of metal oxides formed on the surface of an electrode or similar metallic member. Accordingly, in this conventional mass spectrometer, it is possible to expect that the metal oxide film formed on the surface of an electrode or similar member will be removed in the maintenance process of the device, so that the unwanted charge-up is less likely to occur in the next analysis.

However, for example, in the case of a liquid chromatograph mass spectrometer which includes a liquid chromatograph connected to the front end of a mass spectrometer, an analysis of a single sample often requires a lengthy period of time, which in some cases may cause analysis sensitivity to deteriorate due to the gradual contamination of an electrode or similar member as time passes from the beginning of the analysis. Another problem is that, once an electrode or similar member has been seriously contaminated, a considerable period of time is required to remove oxides by supplying hydrogen radical in the device maintenance process.

The present invention has been developed to solve these problems. Its primary objective is to provide an ion analyzer and an ion analyzing method which can improve the efficiency of radical-induced dissociation by preventing or reducing the contamination of an electrode or similar member due to a radical used for the radical-induced dissociation.

### Solution to Problem

One mode of the ion analyzer according to the present invention is an ion analyzer configured to analyze an ion dissociated by an effect of a radical, the ion analyzer including:
a generator configured to generate a radical from a source gas;
a gas supplier configured to supply a gas mixture as the source gas to the generator during an analysis, the gas mixture prepared by mixing a first gas which is a source for a radical having oxidizing power or which itself has oxidizing power, and a second gas which is a source for a radical having reducing power or which itself has reducing power, at a predetermined ratio specified so that the efficiency of the dissociation by the radical originating from the first gas is not lower than that in the case where the second gas is not mixed; and
a reaction chamber into which a radical generated by the generator is introduced and within which an ion originating from a sample is dissociated by the radical coming in contact with the ion.

One mode of the ion analyzing method according to the present invention is an ion analyzing method for analyzing an ion dissociated within a reaction chamber, using an ion analyzer including a generator configured to generate a radical from a source gas and the reaction chamber into which a radical generated by the generator is introduced and within which an ion originating from a sample is dissociated by the radical coming in contact with the ion, the method including the step of supplying a gas mixture as the source gas to the generator during an analysis, the gas mixture prepared by mixing a first gas which is a source for a radical having oxidizing power or which itself has oxidizing power, and a second gas which is a source for a radical having reducing power or which itself has reducing power, at a predetermined ratio specified so that the efficiency of the dissociation by the radical originating from the first gas is not lower than that in the case where the second gas is not mixed.

### Advantageous Effects of Invention

In the previously described modes of the ion analyzer and the ion analyzing method according to the present invention, a first gas, e.g. steam, which is a source for a radical having oxidizing power, and a second gas, e.g. hydrogen gas, which is a source for a radical having reducing power, are mixed at a predetermined ratio and supplied together to the generator, not selectively. However, mixing the first and second gases to prepare the source gas in this manner may possibly deteriorate the efficiency of the radical-induced dissociation since the radical generated from the second gas can bond to or react with the radical generated from the first gas, causing a decrease in the amount of radical originating from the first gas. For example, when steam and hydrogen gas are mixed to prepare the source gas, the hydrogen radical originating from the hydrogen gas bonds to or reacts with the hydroxyl radical originating from the steam, causing a decrease in the amount of hydroxyl radical which contributes to the radical-induced dissociation. Accordingly, in the present invention, the mixture ratio of the second gas in the source gas is limited so that the radical originating from the second gas will not be extremely abundant and cause the efficiency of the radical-induced dissociation to be lower than in the case where the second gas is not mixed (i.e. when the first gas is solely used). Consequently, within the reaction chamber, the ion originating from the sample is dissociated primarily due to the effect of the radical generated from the first gas, while oxides formed by the radical on the surface of an electrode or similar member placed within the reaction chamber, for example, are effectively removed by the reducing effect of the radical generated from the second gas.

Thus, the ion analyzer and the ion analyzing method according to the previously described modes of the present invention can prevent or reduce contamination of an electrode or similar member due to a radical used for the radical-induced dissociation, while performing an analysis. This prevents the efficiency of the radical-induced dissociation from deteriorating during the analysis, so that a satisfactory level of analysis sensitivity can be maintained.

### BRIEF DESCRIPTION OF DRAWINGS

FIG. 1 is a schematic configuration diagram of a mass spectrometer as one embodiment of the present invention.

FIG. 2 is a configuration diagram of the main components of a radical generator in the mass spectrometer according to the present embodiment.

FIG. 3 is a diagram showing an example of a total ion current chromatogram which is a measured result of a radical induction MS/MS analysis in which only steam was initially used as the source gas and hydrogen gas was subsequently added.

FIG. 4 is a diagram showing an example of the result of an ion-intensity measurement by a radical induction MS/MS analysis in which the mixture ratio of the steam and hydrogen gas in the source gas was varied.

FIG. 5 is a control flowchart of a radical induction MS/MS analysis in the mass spectrometer according to the present embodiment.

### DESCRIPTION OF EMBODIMENTS

One embodiment of the ion analyzer and the ion analyzing method according to the present invention is hereinafter described with reference to the attached drawings. Although the following descriptions address a mass spectrometer as an embodiment of the ion analyzer, it is evident from the following descriptions that the present invention is not limited to this type of device but may also be applied in an ion mobility spectrometer or ion mobility-mass spectrometer.

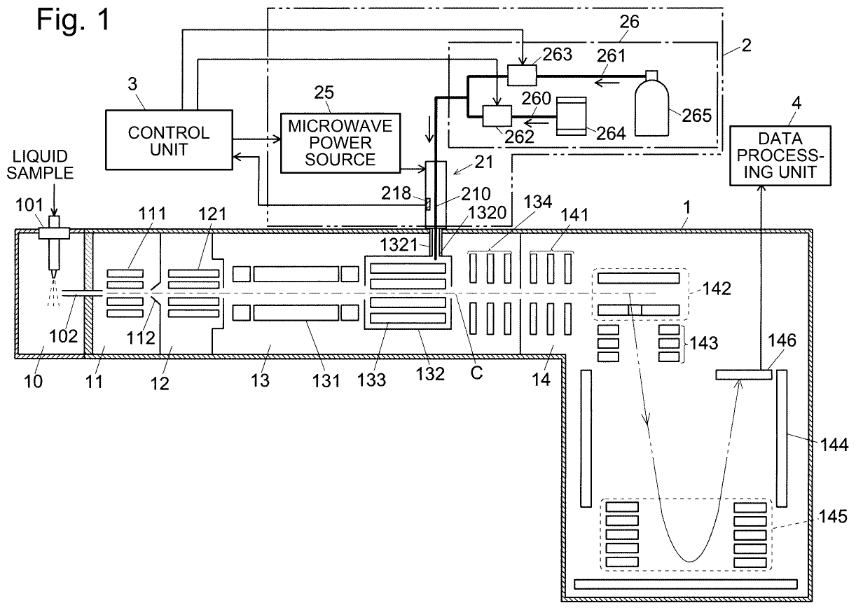

FIG. 1 is a schematic configuration diagram of the mass spectrometer according to the present embodiment. This mass spectrometer is a quadrupole time-of-flight (Q-TOF) mass spectrometer including an atmospheric pressure ion source.

As shown in FIG. 1, this mass spectrometer includes an ionization chamber 10 and a vacuum chamber 1. The inside of the ionization chamber 10 is at substantially atmospheric pressure. The inner space of the vacuum chamber 1 is divided into a plurality of sections (in the present embodiment, four chambers, for example), which are a first intermediate vacuum chamber 11, second intermediate vacuum chamber 12, first analysis chamber 13 and second analysis chamber 14 sequentially arranged from the ionization chamber 10. Each of these chambers is evacuated by a vacuum pump (a rotary pump and/or a turbomolecular pump, not shown), forming the configuration of a multi-stage differential pumping system in which the degree of vacuum sequentially increases in the direction from the ionization chamber 10 toward the second analysis chamber 14.

The ionization chamber 10 is provided with an electrospray ionization (ESI) probe 101 configured to spray a liquid sample while imparting electric charges to the same sample (i.e., to electrostatically spray the liquid sample). The ionization chamber 10 communicates with the first intermediate vacuum chamber 11 through a thin desolvation tube 102. The first intermediate vacuum chamber 11 is separated from the second intermediate vacuum chamber 12 by a skimmer 112 having a small hole at its apex. Ion guides 111 and 121 are located within the first and second intermediate vacuum chambers 11 and 12, respectively. Within the first analysis chamber 13, a quadrupole mass filter 131 configured to separate ions according to their m/z, a collision cell 132 having a multipole ion guide 133 inside, and an ion transport electrode 134 for transporting ions, are arranged along an ion beam axis C. The quadrupole mass filter 131 and the multipole ion guide 133 are each formed by a plurality of rod electrodes, while the ion transport electrode 134 is formed by a plurality of ring electrodes arrayed along the ion beam axis C.

The collision cell 132 has an opening 1320 formed in its wall, with a cylindrical tube connection member 1321 provided so that one of its ends surrounds the opening 1320. A quartz tube 210 extending from a radical generation unit 2 is inserted into the tube connection member 1321. The end of the quartz tube 210 protrudes through the opening 1320 into the collision cell 132. Within the collision cell 132, an ion is dissociated by radicals supplied from the radical generation unit 2, as will be described later. Though not shown, the collision cell 132 may be configured to receive a supply of gas for causing collision-induced dissociation (CID) within the collision cell 132 (typically, argon gas), other than the radicals supplied from the radical generation unit 2.

Within the second analysis chamber 14, the following components are arranged: an ion transport electrode 141 for transporting ions coming from the first analysis chamber 13; an orthogonal accelerator 142 including a pair of electrodes facing each other across the ion beam axis C; a plurality of acceleration electrodes 143; a flight tube 144 internally forming a flight space; a reflectron electrode 145 configured to form a return path for ions within the flight space; and an ion detector 146 configured to detect ions. For example, the ion detector 146 may be a multichannel plate detector. The detection signals produced by the ion detector 146 are sent to a data processing unit 4. A control unit 3 is configured to control the radical generation unit 2 and the data processing unit 4 as well as other components, including power sources for applying voltages to the related elements, although the signal lines required for the control are partially omitted in the drawing.

A typical MS/MS analysis operation performed under the control of the control unit 3 in the mass spectrometer configured in the previously described manner is as follows:

The ESI probe 101 sprays a liquid sample into the ionization chamber 10 while imparting electric charges to the same liquid sample, whereby a compound in the liquid sample is ionized. The generated ions are sent into the first intermediate vacuum chamber 11 through the desolvation tube 102. The ions which have entered the first intermediate vacuum chamber 11 are transferred through the ion guide 11, small hole of the skimmer 112 and ion guide 121 into the first analysis chamber 13, within which the ions are introduced into the quadrupole mass filter 131.

Among the various kinds of introduced ions, only an ion having a specific m/z value is selectively allowed to pass through the quadrupole mass filter 131 and be introduced into the collision cell 132 as the precursor ion. Meanwhile, radicals are introduced from the radical generation unit 2 into the collision cell 132 through the quartz tube 210. The precursor ion is dissociated by reacting with these radicals. The various product ions resulting from the dissociation are extracted from the collision cell 132 and introduced into the orthogonal accelerator 142 through the ion transport electrodes 134 and 141.

The ions introduced into the orthogonal accelerator 142 along the ion beam axis Care ejected in a direction substantially orthogonal to the ion beam axis C at an appropriate timing. The ejected ions are accelerated by the acceleration electrode 143 and introduced into the flight space within the flight tube 144. The flying ions are repelled by the electric field created by the reflectron electrode 145 and ultimately reach the ion detector 146. The ion detector 146 produces an ion intensity signal corresponding to the amount of ions which have reached the same detector 146. This signal is sent to the data processing unit 4. The period of time from the departure time of an ion from the orthogonal accelerator 142 to the arrival time of the ion at the ion detector 146, i.e., the time of flight of an ion, depends on the m/z value of that ion. Accordingly, based on the ion intensity signals sequentially received with the passage of time, the data processing unit 4 creates a time-of-flight spectrum showing the relationship between time of flight and ion intensity, and further creates a mass spectrum by converting the time of flight into the m/z value.

The detailed configuration of the radical generation unit 2 for generating radicals, as well as its operation, are hereinafter described.

As shown in FIG. 1, the radical generation unit 2 includes a plasma generator 21. The plasma generator 21 generates a cloud of plasma from a source gas, such as steam, supplied from a source-gas supply source 26. The radicals generated in this plasma are supplied to the collision cell 132. A microwave power source 25 supplies the plasma generator 21 with microwave power for generating plasma.

The source-gas supply source 26 incudes a steam supply tube 260 provided with a first mass flow controller (MFC) 262, a hydrogen supply tube 261 provided with a second MFC 263, a water storage unit 264 connected to the inlet end of the steam supply tube 260, and a hydrogen cylinder (or hydrogen generator) 265 connected to the inlet end of the hydrogen supply tube 261. The steam and hydrogen supply tubes 260 and 261 both have their remaining ends connected to the quartz tube 210. The water storage unit 264, which is equipped with a heater (not shown), can generate steam by heating the stored water and supply that steam through the steam supply tube 260.

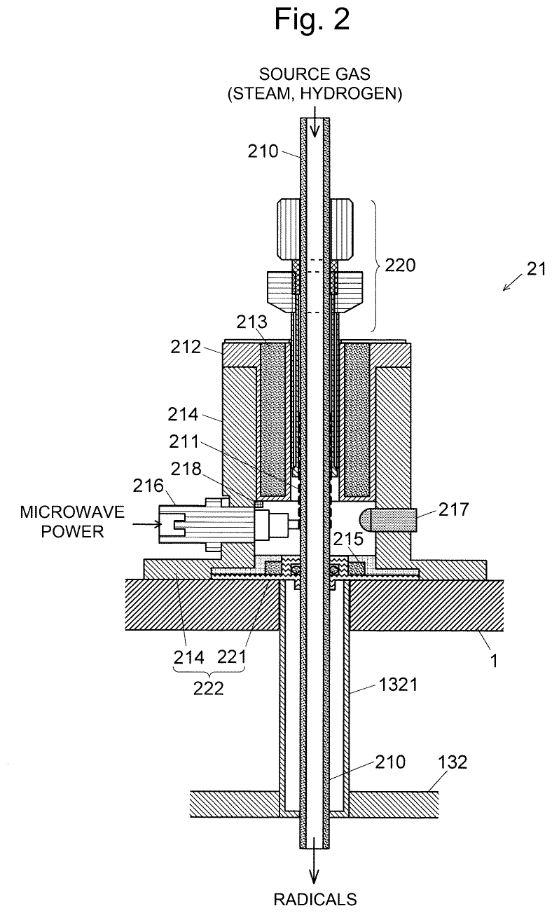

FIG. 2 is a vertical sectional view of the main components including the plasma generator 21.

The plasma generator 21 has the following components: a long quartz tube 210 extending in the vertical direction in FIG. 2; a helical antenna 211 consisting of a strip of conductor helically wound around the outer circumferential surface of a portion of the quartz tube 210; an outer conductive part 212 consisting of a conductor having a cylindrical cavity which is coaxial with the quartz tube 210 and has an inner diameter slightly larger than the outer diameter of the quartz tube 210; a permanent magnet 213 buried in the outer conductive part 212; a casing 214 holding the outer conductive part 212; and a permanent magnet 215 located at the bottom of the casing 214. The casing 214 is provided with a microwave supply connector 216, ultraviolet light source 217 and photodetector 218. When deep ultraviolet light is cast from the ultraviolet light source 217 onto the quartz tube 210, electrons are released from the wall surface of the quartz tube 210. Those electrons spark (ignite) the plasma.

The quartz tube 210 is a source-gas introduction tube for introducing a source gas from the source-gas supply source 26. Additionally, the inner space of this tube partially acts as a generator for generating radicals, and partially as a passage for introducing radicals into the collision cell 132. The microwave supply connector 216 is a coaxial connector to be connected to the microwave power source 25 via a coaxial cable. The conductor wire of the microwave supply connector 216 is connected to one end (in FIG. 2, the lower end) of the helical antenna 211. Though not shown, the outer conductive part 212 is grounded. A portion of the helical antenna 211 is electrically connected to the outer conducive member 212 via a resonator-tuning mechanism 220, and the helical antenna 211 is grounded at the point of that connection. The helical antenna 211, outer conductive part 212, resonator-tuning mechanism 220 and other related elements constitute a resonator for electron cyclotron resonance. The resonator-tuning mechanism 220, an example of which is disclosed in Patent Literature 3, is used for tuning the resonator.

This plasma generator 21 has a configuration called the “ECR-LICP” type which employs localized inductively coupled discharge and electron cyclotron resonance for the generation and maintenance of plasma.

On the bottom side of the casing 214, a substantially disk-shaped magnet holder 221 is attached. The casing 214 and the magnet holder 221 function as a holding member 222 for holding the quartz tube 210. The magnet holder 221 has an opening located substantially at its center through which the quartz tube 210 is to be inserted. As shown in FIG. 2, the plasma generator 21 is attached to the outer surface of the vacuum chamber 1, and the quartz tube 210 held by the holding member 222 is inserted into the tube connection member 1321 connecting the collision cell 132 and the vacuum chamber 1, reaching the inside of the collision cell 132. Since the inner space of the quartz tube 210 communicates with that of the collision cell 132, the inside of the quartz tube 210 will be in a vacuum state when no source gas is supplied to the quartz tube 210.

As described earlier, in the mass spectrometer according to the present embodiment, radicals originating from the source gas are generated by inducing, within the quartz tube 210, radio-frequency electric discharge due to the microwave power supplied from the microwave power source 25 while a flow of the source gas is supplied from the source-gas supply source 26 into the quartz tube 210. Those radicals are introduced into the collision cell 132 to carry out an MS/MS analysis using the radical-induced dissociation method. In the present embodiment, users can appropriately select one of the three options as the source gas from which radicals are to be generated in the radical generation unit 2: a gas mixture of steam and hydrogen gas, steam only, or hydrogen gas only.

When steam is used as the source gas, hydroxyl radical and oxygen radical can be generated in the radical generation unit 2. When hydrogen gas is used as the source gas, hydrogen radical can be generated in the radical generation unit 2. As disclosed in Patent Literature 2, hydroxyl and oxygen radicals are particularly useful for analyzing the location of a double bond which determines the bioactivity of a lipid.

Thus, hydroxyl radical and oxygen radical are useful radical species for radical-induced dissociation. However, due to their strong oxidizing power, they unfavorably promote the oxidization of metallic members, such as the surface of the multipole ion guide 133 located within the collision cell 132 or the inner wall surface of the collision cell 132. Most of the metal oxides formed by this oxidization are insulating materials. If an insulating film is formed on the surface of an electrode or similar member, unwanted charge-up occurs in the middle of the analysis. If the charge-up occurs, the electric field created by the electrode cannot be in the intended state and possibly causes the ion passage efficiency to deteriorate. As already noted, the mass spectrometer described in Patent Literature 4 introduces hydrogen radical having the reducing power into the collision cell when the device is operated in maintenance mode and no analysis is performed, in order to remove oxides formed on the electrode surface and other related areas. However, this method cannot prevent or alleviate the contamination of electrodes (or the like) which occurs while an analysis is performed, so that the efficiency of the radical-induced dissociation may possibly deteriorate with the passage of time.

By comparison, in the mass spectrometer according to the present embodiment, hydrogen gas is supplied into the quartz tube 210 during the MS/MS analysis simultaneously with the steam from which the radical for radical-induced dissociation is to be generated. Due to the reducing power of the hydrogen radical generated from the hydrogen gas (and that of the hydrogen gas itself), the oxides on the electrode surface and other related areas are removed even while the MS/MS analysis is being performed.

Hereinafter described is the result of an experiment performed for confirming the ion-intensity increasing effect obtained when the hydrogen gas is supplied into the quartz tube 210 simultaneously with the steam.

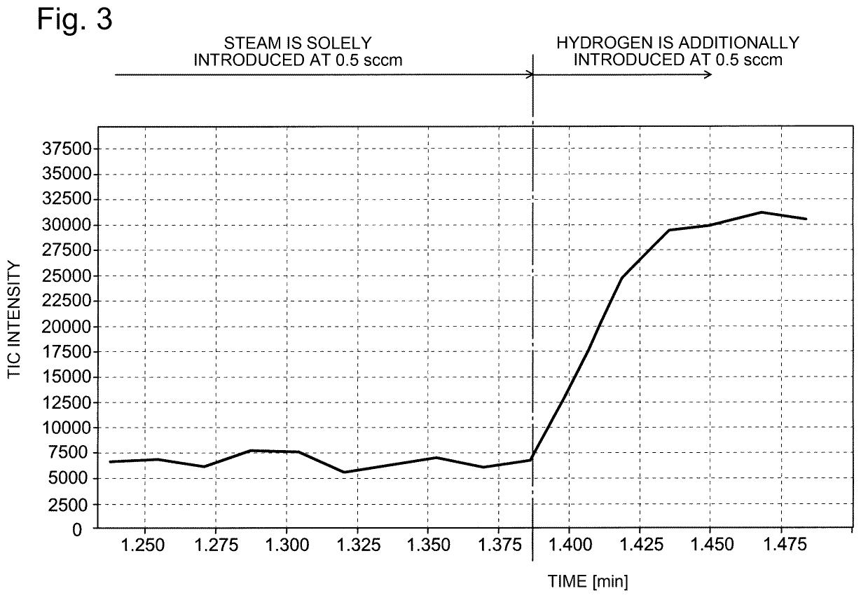

FIG. 3 shows an example of a total ion current chromatogram as a measured result of a radical induction MS/MS analysis in which only steam was initially used as the source gas and hydrogen gas was subsequently added (i.e., the source gas was changed to a gas mixture of steam and hydrogen). In this measurement, the total ion current acquired by an MS/MS analysis was observed while the same sample (in the present case, NaI was used) was continuously supplied to the ESI probe 101. Steam was solely supplied at a flow rate of 0.5 sccm as the source gas until approximately 1.39 minutes from the beginning of the analysis. When approximately 1.39 minutes had passed, hydrogen gas was added at a flow rate of 0.5 sccm while the flow rate of the steam was maintained. In other words, the gas mixture ratio was 1:1 when the hydrogen was added.

FIG. 3 shows that the ion intensity increased rapidly and noticeably when the hydrogen gas was additionally introduced from the state where steam was solely used as the source gas. The reason for this result can be inferred as follows: Due to the reducing effect of the hydrogen radical generated from the hydrogen gas, the oxides formed on the surface of the electrodes were removed, so that the electric field created by the multipole ion guide 133 and other components was approximately restored to its intended state, which resulted in the recovery of the ion passage efficiency and further to the recovery of the efficiency of the radical-induced dissociation.

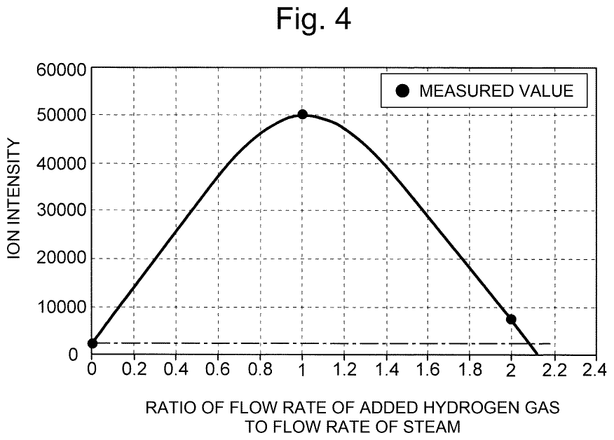

FIG. 4 is an example of the result of an experiment in which a change in the ion intensity of a predetermined product ion generated by radical-induced dissociation was measured in the case where the flow rate of the added hydrogen gas was varied relative to the flow rate of the steam. Since the product ion is an ion generated by radical-induced dissociation (e.g., the ion is barely generated by other kinds of dissociation, such as collision-induced dissociation), it is possible to consider that the higher the ion intensity of this product ion is, the higher the efficiency of the radical-induced dissociation is. What can be understood from the results in FIG. 4 is as follows:
The change in ion intensity for a change in the mixture ratio of the hydrogen gas is considerably large. There is unmistakably an optimum value of the mixture ratio of the steam and hydrogen gas from the point of view of ion intensity.
The ion intensity has the highest value when the flow rate of the hydrogen gas is comparable to that of the steam (i.e. the mixture ratio is approximately 1:1). In other words, the efficiency of the radical-induced dissociation is almost maximized under this condition.
The ion intensity becomes low when the flow rate of the hydrogen gas is too high, not to mention the case where no hydrogen gas is supplied (i.e., when the flow rate of the hydrogen gas equals zero). In particular, in the present example, when the ratio of the flow rate of the hydrogen gas exceeds a range from 2 to 2.1, the addition of the hydrogen gas produces the opposite effect, causing the ion intensity to be lower than the ion intensity in the case where no hydrogen gas is supplied (i.e., the level when the flow rate of the hydrogen gas equals zero, which is indicated by the horizontal long-dashed short-dashed line in FIG. 4).

The previously described experimental results can be physically explained as follows:

When the steam and hydrogen gas are simultaneously supplied, if the flow rate of the hydrogen gas is too low, the oxidizing power of the hydroxyl radical (or the like) exceeds the reducing power of the hydrogen radical, so that the reducing effect cannot be sufficiently obtained, and the ion intensity cannot be easily improved. On the other hand, if the flow rate of the hydrogen gas relative to the steam is too high, the chance of contact between the hydroxyl radical and the hydrogen radical increases, so that the two radicals can more easily bond to or react with each other. Consequently, the amount of hydroxyl radical which contributes to the intended radical-induced dissociation decreases, which leads to a decrease in the efficiency of the radical-induced dissociation and further to a decrease in ion intensity.

From these considerations, it can be understood that the mixture ratio of the hydrogen gas to the steam needs to be lower than a predetermined value in order to satisfy the minimum requirement that the ion intensity should exceed the level achieved when no hydrogen gas is mixed (i.e., only steam is used as the source gas). In the example of FIG. 4, that value of the mixture ratio is approximately “steam”:“hydrogen gas” =1:2. It should be noted that this is the minimum requirement; as a more general condition, it is preferable to set the flow rate of the hydrogen gas at a level where the hydrogen radical is generated in a sufficient amount for satisfactorily exhibiting its reducing power, while avoiding the generation of an excessive amount of hydrogen radical that causes the bonding to or reaction with the hydroxyl radical to actively occur. In other words, the mixture ratio of the steam and hydrogen gas should produce an appropriately balanced condition. According to the measured example shown in FIG. 4, the optimum mixture ratio of the steam and hydrogen gas is approximately 1:1.

An ion intensity equal to or higher than approximately 80% of its maximum value is achieved when the ratio of the flow rate of the hydrogen gas to that of the steam is approximately within a range from 0.7 to 1.4. Furthermore, an ion intensity equal to or higher than approximately 60% of its maximum value is achieved when the ratio of the flow rate of the hydrogen gas to that of the steam is approximately within a range from 0.46 to 1.6. The change in ion intensity from the state where no hydrogen gas is mixed to the state where the mixture ratio of the steam and hydrogen gas is approximately 1:1 can be considered to be an approximately monotonic increase. Therefore, it is possible to consider that mixing the hydrogen gas at an extremely low ratio is already effective in improving the efficiency of the radical-induced dissociation. As will be described later, those ranges of numerical values are likely to depend on the kinds of gases used and other related conditions. Accordingly, appropriate values or ranges should be previously searched for according to the kinds of gases to be used and other related conditions.

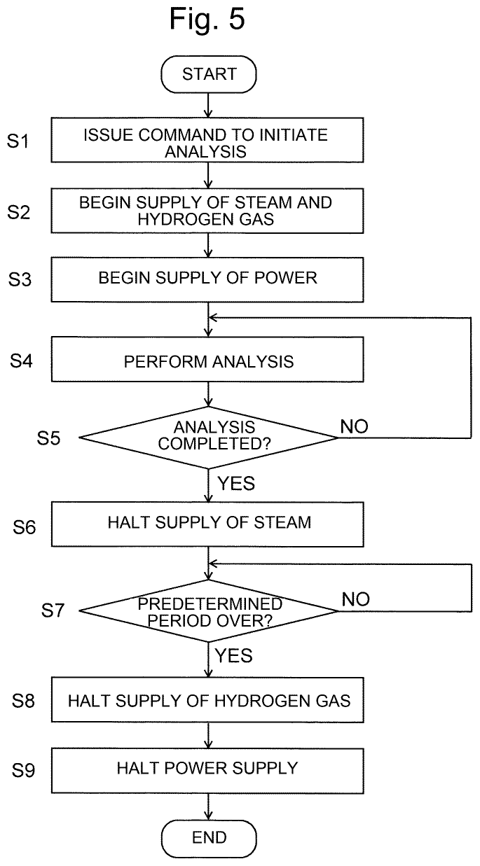

A typical control procedure for carrying out a radical induction MS/MS analysis in the mass spectrometer according to the present embodiment is hereinafter described with reference to the flowchart shown in FIG. 5.

A command to initiate an analysis is issued, for example, by a user (Step S1). Upon receiving this command, the control unit 3 initially operates the first and second mass flow controllers (MFCs) 262 and 263 so as to supply steam and hydrogen gas at their respective predetermined flow rates. The gas mixture of the steam and hydrogen gas is thereby supplied from the source-gas supply source 26 to the quartz tube 210 as the source gas and further flows through the plasma generator 21 into the collision cell 132 (Step S2). The gas flow rates in this step can be 0.5 sccm for steam and 0.5 sccm for hydrogen gas, for example, on the assumption that the mixture ratio of 1:1 yields the maximum ion intensity, as described earlier. The appropriate ratio (or values) of the flow rate in the case of supplying a mixture of steam and hydrogen gas in this manner can be previously determined by experiments (or the like) and stored in an internal memory of the control unit 3. In that case, the control unit 3 can control each of the MFCs 262 and 263 based on the information read from that memory.

The control unit 3 subsequently energizes the microwave power source 25 in order to spark the plasma which is in the OFF state. The energized microwave power source 25 begins to supply a specified amount of microwave power to the plasma generator 21 (Step S3). The microwave has, for example, a frequency of 2.5 GHz. The control unit 3 also energizes the ultraviolet light source 217 to initiate emission of deep ultraviolet light for helping the sparking of the plasma. Due to the supply of the microwave power into the quartz tube 210, the source gas supplied in the previously described manner is ionized, and the plasma ignites.

The photodetector 218 detects light of a wavelength band including the wavelength of the light emitted from the plasma. By monitoring the output signal from the photodetector 218, the control unit 3 can confirm, based on the signal value, that the plasma is in the ON state. After the ignition of the plasma has been confirmed, the control unit 3 applies predetermined voltages to the electrodes of the quadrupole mass filter 131 and other related elements, respectively, through power sources (not shown) to carry out a radical induction MS/MS analysis (Step S4). During this radical induction MS/MS analysis, the gas mixture of the steam and hydrogen gas is continuously supplied to the quartz tube 210 as the source gas, and therefore, both the hydroxyl and oxygen radicals generated from the steam and the hydrogen radical generated from the hydrogen gas are introduced into the collision cell 132. Accordingly, within the collision cell 132, an ion originating from a sample (precursor ion) undergoes radical-induced dissociation due to those radicals, while the contamination of the surface of the electrodes of the multipole ion guide 133 and other related elements is removed primarily due to the reducing power of the hydrogen radical. When a specific condition for discontinuing the analysis, such as the end of the predetermined period of time, has been satisfied (“Yes” in Step S5), the control unit 3 discontinues the analyzing operation.

When discontinuing the analysis, the control unit 3 operates the first MFC 262 to halt the supply of the steam (Step S6). Meanwhile, the supply of the hydrogen gas is continued, so that only the hydrogen radical and the hydrogen gas are introduced into the collision cell 132. Since the hydroxyl and oxygen radicals are no longer introduced into the collision cell 132, the oxidization of the electrode surface and other related areas will no longer progress, and the oxides formed on the electrode surface can be satisfactorily removed by the reducing power of the hydrogen radical. After a predetermined period of time has passed since the supply of the steam was halted, the control unit 3 operates the second MFC 263 to also halt the supply of the hydrogen gas (Step S8). The same unit also simultaneously halts the power supply from the microwave power source 25 (Step S9). Thus, the introduction of the radicals and gases into the collision cell 132 is completely discontinued.

According to the processing of Steps S6 through S9, the hydrogen gas is solely supplied into the quartz tube 210 as the source gas for a certain period of time after the supply of the steam has been halted. If the supplies of steam and hydrogen gas were simultaneously halted, the oxides present on the electrode surface immediately before the discontinuation of the gas supply would possibly remain without being sufficiently removed. There is also the possibility that the hydroxyl radical, oxygen radical or other particles having oxidizing power still remain within the collision cell 132 for a certain period of time even after the supply of the steam has been halted, in which case the electrode surface of the multipole ion guide 133 and other related components may possibly be further oxidized due to the oxidizing power of those particles.

By comparison, in the mass spectrometer according to the present embodiment, the timing when the supply of the hydrogen gas is halted is delayed from the timing when the supply of the steam is halted. Therefore, even after the hydroxyl and oxygen radicals have been almost entirely discharged from the collision cell 132, the hydrogen radical still remains within the collision cell 132 for a certain period of time. This period of time allows the hydrogen radical to sufficiently reduce and remove oxides on the electrode surface and other related areas. Thus, the mass spectrometer according to the present embodiment can prevent the situation in which electrodes and other metallic members are left in an oxidized state at the completion of the analysis.

The previously described process of controlling the gas supply at the completion of the analysis can be performed not only at the completion of the analysis but also when the radical-induced dissociation is temporarily halted, as in the case where the analysis is suspended (paused) or switched from the radical-induced dissociation to the CID.

In the previous description, the supplies of steam and hydrogen gas are individually halted by controlling their flow rates using the MFCs 262 and 263. It is also possible to halt the supply of each gas by closing a simple on/off valve. In place of the electrical control system for halting the supplies of steam and hydrogen radical at different timings, a mechanical delay system may be used in which the supply of the hydrogen gas is halted at a delayed point in time after the supply of the steam to the plasma generator 21 has been halted.

For example, in FIG. 1, it is possible to design the section of the hydrogen supply tube 261 downstream from the second MFC 263 (the section between the second MFC 263 and the connection point of the quartz tube 210) to be sufficiently longer than the section of the steam supply tube 260 downstream from the first MFC 261 so that, when the supply of gas is simultaneously halted at both MFCs 262 and 263, the steam in the source gas supplied into the plasma generator 21 through the quartz tube 210 is blocked earlier, and the hydrogen gas is blocked at a later point in time delayed by an amount corresponding to the difference in length between the two tubes (until then, the hydrogen gas is solely supplied).

In the mass spectrometer according to the previously described embodiment, steam is used as the first gas from which the radical for radical-induced dissociation is to be generated, while hydrogen gas is used as the second gas having reducing power. The kinds of first and second gases are not limited to those examples. The first gas may be any kind of gas as long as a radical that is useful for the intended form of radical-induced dissociation (in which a product ion to be observed is generated by dissociation) can be generated from that gas, and as long as that radical has oxidizing power or the gas itself has oxidizing power. Examples of the first gas include oxygen gas, ozone gas, and a gas containing a gasified compound including oxygen atom (e.g., water), in addition to the already mentioned steam. On the other hand, the second gas may be any kind of gas from which a radical having reducing power can be generated or which itself has reducing power. Other than the already mentioned hydrogen gas, the second gas may be nitrogen gas, or a gasified compound including hydrogen atom, nitrogen atom or oxygen atom, such as carbon monoxide.

The degree of oxidizing or reducing power varies depending on the kind of gas used. Therefore, when a mixture of the first and second gases is supplied, it depends on the kinds of gases what mixture ratio is optimum, i.e., what mixture ratio maximizes the ion intensity of the target product ion, as well as what range of the mixture ratios produces a significant effect in increasing the ion intensity as compared to the case where only the first gas is used. When steam and hydrogen gas are used as the first and second gases, respectively, it can be stated that the optimum mixture ratio is approximately 1:1, and a satisfactory effect can be obtained when the ratio of the flow rate of the hydrogen gas to that of the steam is approximately within a range from 0.46 to 1.6, and furthermore, as the minimum requirement, the ratio of the flow rate of the hydrogen gas to that of the steam should be greater than 0 and not greater than 2. However, those numerical values may possibly change when different kinds of gases are used as the first and second gases. Accordingly, it is preferable to search for an appropriate value or range, e.g., by an experiment, according to the kinds of gases to be used as the source gas, and to control the device so that their flow rates have that appropriate value or fall within that appropriate range.

A possible procedure for the experiment is as follows: An appropriate standard sample is electrostatically sprayed into the ionization chamber 10 as described in the measured example. Under this condition, the mixture ratio of the steam (the gas having the oxidizing power) and hydrogen gas (the gas having the reducing power) is gradually changed, and the intensity of the peak of the target product ion having the same m/z value is monitored to search for an appropriate mixture ratio. Needless to say, the method of the experiment is not limited to this example; the minimum requirement is to locate a mixture ratio at which the ion intensity of the target product ion is higher than in the case where the gas having the reducing power is not mixed. In most cases, the manufacturer of the device performs this experiment and stores the information of the flow-rate values and flow-rate ratio determined from the experimental result in the memory as a set of information for control. However, the device may also be provided with a function which allows users to carry out a similar or corresponding experiment and set or modify the flow-rate ratio or flow-rate values based on the result of the experiment.

The optimum mixture ratio of the first and second gases can change not only due to the kinds of gases used but also due to the gas flow rate itself as well as other factors unrelated to the gas, such as the structure and size of the collision cell 132. Accordingly, for example, it is preferable to search for appropriate values and ranges not only for each kind of gas or flow rate of the gas but also for each model of the mass spectrometer.

The previously described embodiment is an example in which the ion analyzer according to the present invention is applied in a Q-TOF mass spectrometer. It is evident that the present invention is not limited to the Q-TOF type. Specifically, the present invention is also applicable in other types of mass spectrometers in which an ion is dissociated for mass spectrometry, such as a triple quadrupole mass spectrometer, ion trap mass spectrometer or ion trap time-of-flight mass spectrometer.

The present invention is generally applicable in devices configured to dissociate an ion by using a radical generated in plasma and analyze product ions generated by the dissociation. Specifically, for example, the present invention is applicable in an ion mobility spectrometer configured to detect ions after separating them according to their ion mobility, as well as in an ion mobility-mass spectrometer configured to separate ions by using both ion mobility and m/z.

The configuration of the previously described mass spectrometer, and particularly that of the radical generation unit 2 for generating radicals, is a mere example and can naturally be appropriately changed or modified to any configuration that can generate radicals by using plasma. The radicals in the present context include hydroxyl radical, hydrogen radical, oxygen radical, nitrogen radical and other kinds of radicals commonly used for radical-induced dissociation methods, as well as various kinds of molecules and atoms which are in an excited state due to externally imparted energy or in a metastable state.

The previously described embodiment and various modifications are mere examples of the present invention. It is evident that any change, modification, addition or the like appropriately made within the spirit of the present invention will also fall within the scope of claims of the present application.

### Various Modes

A person skilled in the art can understand that the previously described illustrative embodiment is a specific example of the following modes of the present invention.

(Clause 1) One mode of the ion analyzer according to the present invention is an ion analyzer configured to analyze an ion dissociated by an effect of a radical, the ion analyzer including:
a generator configured to generate a radical from a source gas;
a gas supplier configured to supply a gas mixture as the source gas to the generator during an analysis, the gas mixture prepared by mixing a first gas which is a source for a radical having oxidizing power or which itself has oxidizing power, and a second gas which is a source for a radical having reducing power or which itself has reducing power, at a predetermined ratio specified so that the efficiency of the dissociation by the radical originating from the first gas is not lower than that in the case where the second gas is not mixed; and
a reaction chamber into which a radical generated by the generator is introduced and within which an ion originating from a sample is dissociated by the radical coming in contact with the ion.

(Clause 8) One mode of the ion analyzing method according to the present invention is an ion analyzing method for analyzing an ion dissociated within a reaction chamber, using an ion analyzer including a generator configured to generate a radical from a source gas and the reaction chamber into which a radical generated by the generator is introduced and within which an ion originating from a sample is dissociated by the radical coming in contact with the ion, the method including the step of supplying a gas mixture as the source gas to the generator during an analysis, the gas mixture prepared by mixing a first gas which is a source for a radical having oxidizing power or which itself has oxidizing power, and a second gas which is a source for a radical having reducing power or which itself has reducing power, at a predetermined ratio specified so that the efficiency of the dissociation by the radical originating from the first gas is not lower than that in the case where the second gas is not mixed.

In the ion analyzer according to Clause 1 and the ion analyzing method according to Clause 8, the removal of oxides from the surface of an electrode or similar member by the reducing power of the radical generated from the second gas or that of the second gas itself takes place within the reaction chamber in parallel with the dissociation of an ion originating from a sample caused primarily due to the effect of the radical generated from the first gas. Accordingly, the ion analyzer according to Clause 1 and the ion analyzing method according to Clause 8 can prevent or reduce contamination of an electrode or similar member due to a radical used for the radical-induced dissociation, while performing an analysis. This prevents the efficiency of the radical-induced dissociation from deteriorating during the analysis, so that a satisfactory level of analysis sensitivity can be maintained.

(Clauses 2 and 9) In the ion analyzer according to Clause 1 and the ion analyzing method according to Clause 8, the predetermined ratio may be specified so that the flow rate of hydrogen gas is greater than 0 and not greater than 2, with the flow rate of steam defined as 1.

(Clauses 3 and 10) In the ion analyzer according to Clause 2 and the ion analyzing method according to Clause 9, the predetermined ratio may be specified so that the flow rate of hydrogen gas is within a range from 0.4 to 1.6.

(Clauses 4 and 11) In the ion analyzer according to Clause 3 and the ion analyzing method according to Clause 10, the predetermined ratio may be specified so that the flow rate of hydrogen gas is within a range from 0.7 to 1.4.

The ion analyzer according to Clause 2 and the ion analyzing method according to Clause 9 can avoid the situation in which the ion intensity becomes low due to the amount of second gas being so large that the radical originating from the first gas is decreased by bonding to or reacting with the radical originating from the second gas. Therefore, a high level of analysis sensitivity in a radical induction MS/MS analysis can be realized while effectively removing the oxides formed on the electrode surface and other related areas. The ion analyzer according to Clause 3 and the ion analyzing method according to Clause 10 can realize a high level of analysis sensitivity in a radical induction MS/MS analysis by avoiding the situation in which the ion intensity cannot easily increase due to the amount of second gas being so small that the reducing effect of the second gas itself or that of the radical originating from the second gas is insufficient. The ion analyzer according to Clause 4 and the ion analyzing method according to Clause 11 can realize an even higher level of analysis sensitivity.

(Clauses 5 and 12) In the ion analyzer according to one of Clauses 1-4 and the ion analyzing method according to one of Clauses 8-11, the first gas may be steam.

(Clauses 6 and 13) In the ion analyzer according to one of Clauses 1-5 and the ion analyzing method according to one of Clauses 8-12, the second gas may be hydrogen gas.

The ion analyzer according to Clause 5 or 6 and the ion analyzing method according to Clause 12 or 13 can properly eliminate contamination of electrodes while collecting desired data by a radical induction MS/MS analysis.

(Clause 7) In the ion analyzer according to one of Clauses 1-6, the gas supplier may be configured to continue supplying only the second gas for a predetermined period of time after halting the supply of the first gas to the generator at a completion of an analysis.

(Clause 14) The ion analyzing method according to one of Clauses 8-13 may include the step of continuing supplying only the second gas for a predetermined period of time after halting the supply of the first gas to the generator at a completion of an analysis.

In the ion analyzer according to Clause 7 and the ion analyzing method according to Clause 14, even after the first gas and the radical originating from the first gas have been almost completely discharged from the reaction chamber, the radical which has reducing power originating from the second gas or the second gas which itself has reducing power remains within the reaction chamber for some period of time. This period allows the second gas or the radical originating from the second gas to sufficiently reduce and remove oxides on the electrode surface and other related areas. Therefore, the next analysis can be performed after the oxides have been sufficiently removed from the electrode surface and other related areas.

### REFERENCE SIGNS LIST

1 . . . Vacuum Chamber
10 . . . Ionization Chamber
101 . . . ESI Probe
102 . . . Desolvation Tube
11 . . . First Intermediate Vacuum Chamber
111, 121 . . . Ion Guide
112 . . . Skimmer
12 . . . Second Intermediate Vacuum Chamber
13 . . . First Analysis Chamber
131 . . . Quadrupole Mass Filter
132 . . . Collision Cell
1320 . . . Opening
1321 . . . Tube Connection Member
133 . . . Multipole Ion Guide
134, 141 . . . Ion Transport Electrode
14 . . . Second Analysis Chamber
142 . . . Orthogonal Accelerator
143 . . . Acceleration Electrode
144 . . . Flight Tube
145 . . . Reflectron Electrode
146 . . . Ion Detector
2 . . . Radical Generation Unit
21 . . . Plasma Generator
210 . . . Quartz Tube
211 . . . Helical Antenna
212 . . . Outer Conductive Part
213, 215 . . . Permanent Magnet
214 . . . Casing
216 . . . Microwave Supply Connector
217 . . . Ultraviolet Light Source
218 . . . Photodetector
220 . . . Resonator-Tuning Mechanism
221 . . . Magnet Holder
222 . . . Holding Member
25 . . . Microwave Power Source
26 . . . Source-Gas Supply Source
260 . . . Steam Supply Tube
261 . . . Hydrogen Supply Tube
262, 263 . . . Mass Flow Controller (MFC)
264 . . . Water Storage Unit
265 . . . Hydrogen Cylinder
3 . . . Control Unit
4 . . . Data Processing Unit
C . . . Ion Beam Axis

1. An ion analyzer configured to analyze an ion dissociated by an effect of a radical, the ion analyzer comprising:
a generator configured to generate a radical from a source gas;
a gas supplier configured to supply a gas mixture as the source gas to the generator during an analysis, the gas mixture prepared by mixing a first gas which is a source for a radical having oxidizing power or which itself has oxidizing power, and a second gas which is a source for a radical having reducing power or which itself has reducing power, at a predetermined ratio specified so that an efficiency of dissociation by the radical originating from the first gas is not lower than that in a case where the second gas is not mixed; and
a reaction chamber into which a radical generated by the generator is introduced and within which an ion originating from a sample is dissociated by the radical coming in contact with the ion.

2. The ion analyzer according to claim 1, wherein the predetermined ratio is specified so that a flow rate of hydrogen gas is greater than 0 and not greater than 2, with a flow rate of steam defined as 1.

3. The ion analyzer according to claim 2, wherein the predetermined ratio is specified so that the flow rate of hydrogen gas is within a range from 0.4 to 1.6.

4. The ion analyzer according to claim 3, wherein the predetermined ratio is specified so that the flow rate of hydrogen gas is within a range from 0.7 to 1.4.

5. The ion analyzer according to claim 1, wherein the first gas is steam.

6. The ion analyzer according to claim 5, wherein the second gas is hydrogen gas.

7. The ion analyzer according to claim 1, wherein the gas supplier is configured to continue supplying only the second gas for a predetermined period of time after halting a supply of the first gas to the generator at a completion of an analysis.

8. An ion analyzing method for analyzing an ion dissociated within a reaction chamber, using an ion analyzer including a generator configured to generate a radical from a source gas and the reaction chamber into which a radical generated by the generator is introduced and within which an ion originating from a sample is dissociated by the radical coming in contact with the ion, the method comprising a step of supplying a gas mixture as the source gas to the generator during an analysis, the gas mixture prepared by mixing a first gas which is a source for a radical having oxidizing power or which itself has oxidizing power, and a second gas which is a source for a radical having reducing power or which itself has reducing power, at a predetermined ratio specified so that an efficiency of dissociation by the radical originating from the first gas is not lower than that in a case where the second gas is not mixed.

9. The ion analyzing method according to claim 8, wherein the predetermined ratio is specified so that a flow rate of hydrogen gas is greater than 0 and not greater than 2, with a flow rate of steam defined as 1.

10. The ion analyzing method according to claim 9, wherein the predetermined ratio is specified so that the flow rate of hydrogen gas is within a range from 0.4 to 1.6.

11. The ion analyzing method according to claim 10, wherein the predetermined ratio is specified so that the flow rate of hydrogen gas is within a range from 0.7 to 1.4.

12. The ion analyzing method according to claim 8, wherein the first gas is steam.

13. The ion analyzing method according to claim 12, wherein the second gas is hydrogen gas.

14. The ion analyzing method according to claim 8, further comprising a step of continuing supplying only the second gas for a predetermined period of time after halting a supply of the first gas to the generator at a completion of an analysis.
